(19) United States
(12) Patent Application Publication
(10) Pub. No.: US 2008/0031001 A1
(43) Pub. Date: Feb. 7, 2008

(54) DISPLAY APPARATUS HAVING LAMP ATTACHMENT

(75) Inventor: ZHENG-HENG SUN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/768,921

(22) Filed: Jun. 27, 2007

(30) Foreign Application Priority Data
Aug. 2, 2006 (CN) 200610061952.X

(51) Int. Cl. F21V 21/26

(52) U.S. Cl. 362/427

(57) ABSTRACT

A display apparatus includes a monitor with a display screen to show information thereon, a lamp attachment pivotably assembled to the monitor in a back-and-forth direction, and a lamp removably secured in the lamp attachment for providing illumination. The display apparatus can save desktop space for a user via combining a desk lamp with a monitor allowing the user to study or work in a tidy and comfortable space.

### BACKGROUND OF THE INVENTION

1. Field of the Invention

The present invention relates to display apparatuses, and more particularly to a flat panel display assembly having illuminating function.

2. Description of Related Art

Flat panel displays are more and more popularly used in offices. The relative lightness and compactness of flat panel displays (particularly in terms of front to back depth) make them particularly suitable for narrow workspaces. The characteristics of flat panel displays are particularly attractive in a small office/home office setting, because the relatively shallow front to back depth means that the display can be pushed back further from a user than would be possible with an equivalent cathode ray tube (CRT) monitor in many situations, taking up less precious desktop space in a user's work area. Additionally, falling prices of flat panel displays over the last several years, make them even more attractive to SOHO entrepreneurs.

Typically, other office equipment, such as desk lamp, telephone, printer, and so on, takes up premium space on a desktop, to the point of being intrusive or at least inconvenient, adversely affecting work mood and efficiency in a SOHO. Though flat panel displays are increasingly selected for use in offices, desktop space is still at a premium, so desk lamp can particularly exacerbate the problem.

What is desired, therefore, is to provide a flat panel display assembly having illuminating function to save desktop space to facilitate work and study.

### SUMMARY OF THE INVENTION

In one preferred embodiment, a display apparatus includes a monitor with a display screen at a front side thereof to show information thereon, a lamp attachment pivotably connected to the monitor, and a lamp secured in the lamp attachment for providing illumination. The lamp attachment is movable between a first position, where the lamp faces a back side of the monitor, and a second position, where the lamp faces the front side of the monitor.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an exploded perspective view of a display apparatus in accordance with a first embodiment of the present invention, the display apparatus including a monitor, a lamp attachment, and a linear lamp;

FIG. 2 is an assembled view of FIG. 1, with the lamp attachment positioned at the back of the display apparatus;

FIG. 3 shows another aspect view of FIG. 2, with the lamp attachment partially rotated toward the front of the monitor; and

FIG. 4 shows a use state of the display apparatus of FIG. 1, with the lamp attachment positioned at the front of the monitor.

### DETAILED DESCRIPTION OF THE INVENTION

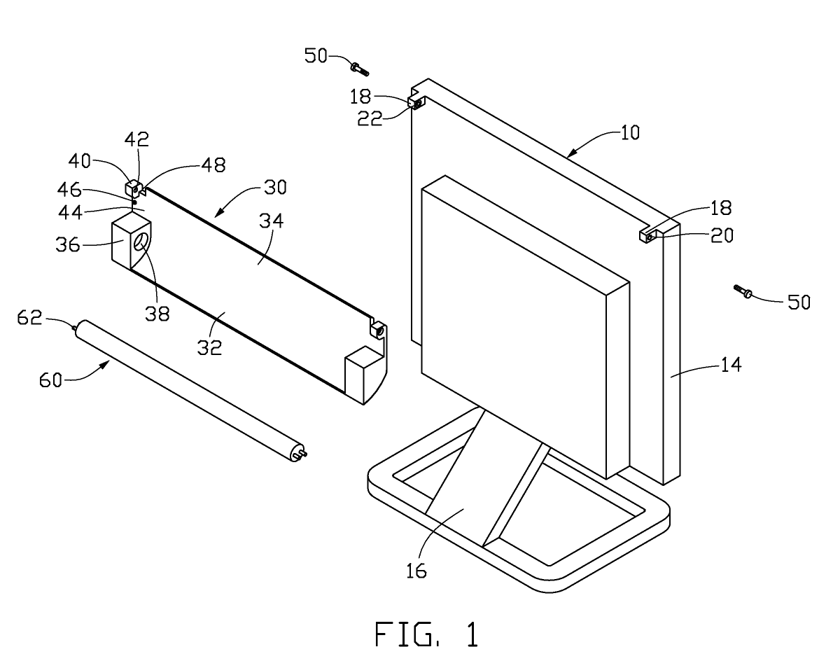

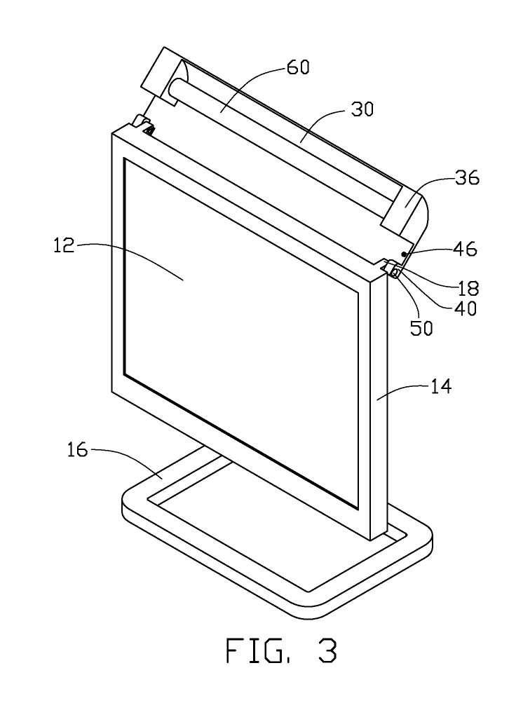

Referring to FIG. 1, in a first embodiment of the invention, a display apparatus includes a monitor 10 with a display screen 12 (see FIG. 3) to show information thereon, a lamp attachment 30 pivotably assembled at a top of the monitor 10, and a linear lamp 60 removably installed in the lamp attachment 30.

The monitor 10 has a housing 14 where there are a circuit board (not shown) and many other electronic components assembled and a support stand 16 for supporting the housing 14, and the display screen 12 is disposed in a front opening of the housing 14. The back of the housing 14 is formed with two installing portions 18 respectively extending from two sides of a top of the housing 14. Each installing portion 18 defines a mounting hole 20. Two nuts 22 are respectively received in the two mounting holes 20.

The lamp attachment 30 includes a lengthwise lampshell 32 in a generally arch-shaped profile for gathering light and a lid portion 34 extending from a long edge of the lampshell 32. Two support portions 36 respectively protrude from two sides of an inner surface of the lampshell 32. Two lamp sockets 38 are respectively formed in two inner sides of the support portions 36. Each lamp socket 38 defines electric apertures therein corresponding to electric pins 62 of one end of the lamp 60. Two pivoting portions 40 are formed respectively in two sides of an inner surface of the lid portion 34, corresponding to the installing portions 18 of the housing 14, thereby defining two holding spaces 44 between the support portions 36 and the corresponding pivoting portions 40 corresponding to front to back depth of the top of the housing 14. Two pivoting holes 42 are respectively defined in the two pivoting portions 40. Two cutouts 48 are defined in the lid portion 34 respectively adjacent the two pivoting portions 40 for accommodating the corresponding two installing portions 18. A trigger power switch 46 is set on the lid portion 34 to control power-on and power-off of the lamp 60.

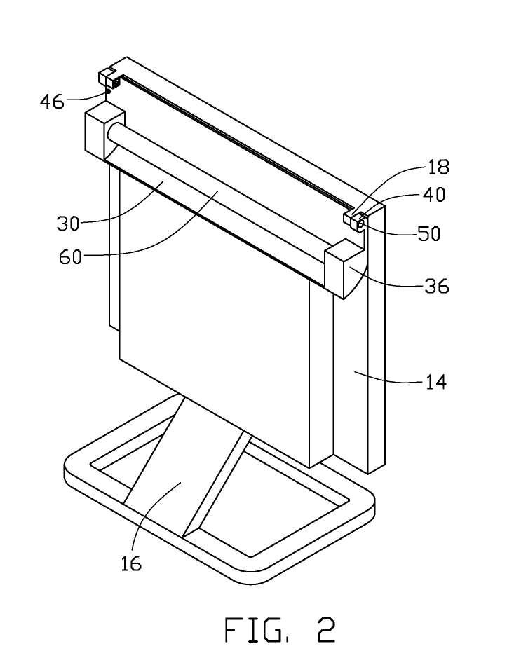

Referring to FIGS. 1 and 2, in assembly, the lamp attachment 30 is attached to the housing 14 with the installing portions 18 received in the cutouts 48 respectively. The pivoting holes 42 of the pivoting portions 40 of the lamp attachment 30 are respectively aligned with the mounting holes 20 of the corresponding installing portions 18 of the housing 14, two connecting members such as connecting bolts 50 are passed through the two pivoting holes 42 and are screwed into the two nuts 22 of the corresponding mounting holes 20, thus, the lamp attachment 30 is pivotably secured at the top of the housing 14 via the pivoting portions 40 of the lamp attachment 30 rotating about the corresponding connecting bolts 50. Initially, the lamp attachment 30 abuts upon the back of the housing 14. The two ends with the electric pins 62 of the lamp 60 are respectively received in the two lamp sockets 38 of the support portions 36, and the electric pins 62 of the ends are respectively inserted in and electrically connected to the corresponding electric apertures, whereby the lamp 60 is secured in the lamp attachment 30.

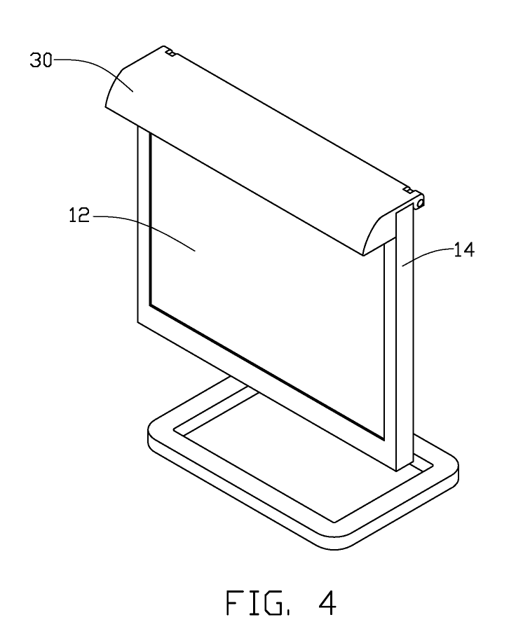

Referring also to FIGS. 3 and 4, when a user wants to study or work with or without the computer powered up, the user may rotate the lamp attachment 30 to the front of the housing 14, and two end portions of the top of the housing 14 are respectively received in the two holding spaces 44 of the lamp attachment 30. The remaining portion of the top of the housing 14 abuts against the lid portion 34 of the lamp attachment 30. The power switch 46 is triggered turning on the lamp 60.

Electric power to the lamp attachment 30 is provided by wires being electrically connected to the circuit board within the housing 14 or to an external power supply.

Alternatively, the trigger power switch 46 may be positioned at other locations on the lamp attachment 30 or the housing 14, for example, it may be disposed at the lower-right corner of the front of the housing 14. The power switch 46 may be a switch of any other desired kind (such as a push switch).

In a second embodiment of the invention, the two installing portions 18 may define two pivoting holes, respectively. Correspondingly, the two pivoting portions 40 may define two mounting holes respectively. Thus, in assembly, two connecting members are respectively passed through the two pivoting holes of the installing portions 18 to be fastened into the two mounting holes of the pivoting portions 40 and the pivoting portions 40 of the lamp attachment 30 and the connecting members 50 are pivotable about the axis of the pivoting holes defined in the installing portions 18 to thereby pivotably assemble the lamp attachment 30 at the top of the housing 14 of the monitor 10.

In a third embodiment of the invention, the mounting holes 20 of the two installing portions 18 may be threaded therein corresponding to threads of the connecting bolts 50. Accordingly, in assembling the lamp attachment 30 to the monitor 10, the two connecting bolts 50 are directly screwed into the corresponding mounting holes 20 through the two pivoting holes 42 of the two pivoting portions 40 without use of nuts.

In a fourth embodiment of the invention, the two installing portions 18 may define two pivoting holes respectively, and the two connecting members may be two rivets or dowels. In installing the lamp attachment 30 to the monitor 1 0, the two rivets or dowels are respectively inserted in the two pivoting holes of the installing portions 18 and the two pivoting holes 42 of the pivoting portions 40, and distal ends of the two rivets or dowels are riveted or dowelled, thus, the lamp attachment 30 is rotatably installed to the monitor 10.

Therefore, the display apparatus having the lamp attachment 30 saves desktop space for the user via combining a desk lamp with a monitor allowing the user to study or work in a tidy and comfortable space.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A display apparatus comprising:
a monitor provided with a display screen at a front side thereof to show information thereon;
a lamp attachment pivotably connected to the monitor; and
a lamp secured to the lamp attachment for providing illumination, wherein the lamp attachment is movable between a first position where the lamp faces a back side of the monitor and a second position where the lamp faces the front side of the monitor.

2. The display apparatus as described in claim 1, wherein the monitor comprises a housing in which the display screen is mounted, at least one installing portion extends from the housing, and at least one pivoting portion is formed on the lamp attachment and rotatably mounted to the at least one installing portion.

3. The display apparatus as described in claim 2, wherein the at least one installing portion and the at least one pivoting portion respectively define a mounting hole and a pivoting hole corresponding to the mounting hole, and a connecting member is passed through the pivoting hole to be fixed into the mounting hole and the lamp attachment is rotatable about the monitor via the at least one pivoting portion rotating about the connecting member.

4. The display apparatus as described in claim 3, wherein the mounting hole of the at least one installing portion is a threaded hole, the connecting member is a connecting bolt, and the connecting bolt is screwed into the threaded hole.

5. The display apparatus as described in claim 3, wherein the mounting hole of the at least one installing portion is provided with a nut therein, the connecting member is a connecting bolt, and the connecting bolt is screwed into the nut in the mounting hole.

6. The display apparatus as described in claim 2, wherein the at least one installing portion and the at least one pivoting portion respectively define a pivoting hole and a mounting hole corresponding to the pivoting hole, and a connecting member is passed through the pivoting hole to be fixed into the mounting hole and the lamp attachment is rotatable about the monitor via the at least one pivoting portion and the connecting member rotating about an axis of the pivoting hole.

7. The display apparatus as described in claim 2, wherein the at least one installing portion and the at least one pivoting portion respectively define a first pivoting hole and a second pivoting hole corresponding to the first pivoting hole, and a connecting member is passed through the first pivoting hole and second pivoting hole and two distal ends of the connecting member are riveted.

8. The display apparatus as described in claim 1, wherein the lamp attachment comprises a lampshell for gathering light, and the lampshell comprises at least one lamp socket for installing the lamp therein.

9. The display apparatus as described in claim 8, wherein the lamp attachment further comprises a lid portion extending from an edge of the lampshell and configured for abutting against a side of the monitor when the lamp attachment is rotated to the second position.

10. The display apparatus as described in claim 1, wherein a switch for controlling power-on and power-off of the lamp is disposed on one of the monitor and the lamp attachment.

11. A display apparatus comprising:
a monitor;
a lamp attachment configured for installing a lamp thereto; and
a rotating mechanism mounting the lamp attachment to the monitor and allowing the lamp attachment to rotate relative to the monitor.

12. The display apparatus as described in claim 11, wherein the rotating mechanism comprises at least one installing portion fixed with the monitor, at least one pivoting portion fixed with the lamp attachment, and a connecting member rotatably connecting the at least one installing portion and the at least one pivoting portion.

13. The display apparatus as described in claim 12, wherein the at least one installing portion and the at least one pivoting portion respectively define a mounting hole and a pivoting hole corresponding to the mounting hole, and a connecting member is passed through the pivoting hole to be fixed into the mounting hole and the at least one pivoting portion is rotatable about the connecting member.

14. The display apparatus as described in claim 13, wherein the mounting hole of the at least one installing portion is a threaded hole, the connecting member is a connecting bolt, and the connecting bolt is screwed into the threaded hole.

15. The display apparatus as described in claim 12, wherein the at least one installing portion and the at least one pivoting portion respectively define a first pivoting hole and a second pivoting hole corresponding to the first pivoting hole, and a connecting member is passed through the first pivoting hole and the second pivoting hole and two distal ends of the connecting member are riveted.

16. The display apparatus as described in claim 12, wherein the at least one installing portion and the at least one pivoting portion respectively define a pivoting hole and a mounting hole corresponding to the pivoting hole, and a connecting member is passed through the pivoting hole to be fixed into the mounting hole and the lamp attachment is rotatable about the monitor via the at least one pivoting portion and the connecting member rotating about an axis of the pivoting hole.
